(19) United States
(12) Patent Application Publication
(10) Pub. No.: US 2022/0412877 A1
(43) Pub. Date: Dec. 29, 2022

(54) THREE-DIMENSIONAL DOSIMETRY PROCEDURES, METHODS AND DEVICES, AND OPTICAL CT SCANNER APPARATUS WHICH UTILIZES FIBER OPTIC TAPER FOR COLLIMATED IMAGES

(71) Applicant: THE TRUSTEES OF COLUMBIA UNIVERSITY IN THE CITY OF NEW YORK, New York, NY (US)

(72) Inventors: Cheng-Shie WUU, Fort Lee, NJ (US); Xin QIAN, Smithtown, NY (US)

(21) Appl. No.: 17/902,781

(22) Filed: Sep. 2, 2022

Related U.S. Application Data
(63) Continuation-in-part of application No. PCT/US2021/021203, filed on Mar. 5, 2021.
(60) Provisional application No. 62/985,629, filed on Mar. 5, 2020.

(51) Int. Cl. G01N 21/03; G02B 6/06; G01N 21/59; H04N 5/372

(52) U.S. Cl. CPC G01N 21/0303; G02B 6/06; G01N 21/59; H04N 5/372; G01N 2021/177

(57) ABSTRACT

Exemplary optical scanner apparatus, method and computer-accessible medium for obtaining information regarding the sample can be provided. In certain exemplary embodiments of the present disclosure, the optical scanner, method and computer-accessible medium can utilize a container configured to hold the sample which is provided in a fluid. A light source can be provided which is configured to emit a light radiation to the container and the sample. Further, with an optic taper, it is possible to receive, taper and combine substantially parallel beams of an output radiation exiting the sample. The output radiation can be provided in response to an irradiation of the sample by the light radiation. Further, using a light detector, it is possible to receive and detect the combined tapered parallel beams so as to obtain the information regarding the sample.

### CROSS-REFERENCE TO RELATED APPLICATION(S)

This application is a continuation-in-part of International Patent Application No. PCT/US2021/021203, filed on Mar. 5, 2021 that published as International Patent Publication No. WO 2021/178889 on Sep. 10, 2021, and also relates to and claims priority from U.S. Patent Application No. 62/985,629, filed on Mar. 5, 2020, the entire disclosure of which are incorporated herein by reference.

### FIELD OF THE DISCLOSURE

The present disclosure relates to exemplary embodiment of three-dimensional dosimetry procedures, methods and devices, and optical CT scanner apparatus which utilizes fiber optic taper for collimated images.

### BACKGROUND INFORMATION

Optical CT scanners have been used for three-dimensional (3D) scanning of polymer gels and radiochromic plastic dosimeters for more than 20 years. However, 3D dosimetry has been limited to research studies, and 3D dosimetry has not been used in the routine clinical QA. Optical CT scanners can be categorized as single-beam and broad-beam geometries. An exemplary single-beam optical CT scanner, modified from original commercial OCTOPUS scanner, has been used for various 3D dosimetry studies (see, e.g., Refs. 1-3) and was considered the “gold standard” technique in light of previous studies showing its accuracy. One of the problems, among others, with this type scanner is that the scanning time for a 3D dosimeter can be very long, e.g., 8-10 hours. The broad-beam optical CT scanner with telecentric lenses design may have a faster scanning time (e.g., less than 10 minutes), although the dosimetry accuracy may not be as accurate due to stray light and spectral artifacts. Both stray light and spectral artifacts may be caused by internal scatter within the imaging lenses and 3D dosimeter.

Accordingly, there is a need to address and/or overcome at least some of the deficiencies with the prior devices, methods and systems described herein above.

### SUMMARY OF EXEMPLARY EMBODIMENTS

To that end, an exemplary broad-beam optical CT scanner can be provided according to exemplary embodiments of the present disclosure, that can utilize fiber optic taper for collimated images, e.g., for fast, high resolution, and accurate dose readout of 3D dosimeters. The exemplary scanning time for a complete three-dimensional dataset acquisition can be less than 10 minutes. For example, the performance of this optical CT scanner for 3D dosimetry was evaluated by comparison with the 3D readout from single laser beam optical scanner.

Exemplary system, method and computer-accessible medium for an optical CT scanner according to various exemplary embodiments of the present disclosure is provided. In certain exemplary embodiments of the present disclosure, the system, method and computer-accessible medium can include, e.g., a light source (e.g., an illuminator), an aquarium comprising a motor for rotating a sample, a fluid, an optic taper, and a camera. According to certain exemplary embodiments of the present disclosure, the aquarium can be provided and/or situated between the light source and the optic taper, and the optic taper can be provided and/or situated between the aquarium and the camera. In certain exemplary embodiments of the present disclosure, the camera can be a CCD camera.

According to certain exemplary embodiments of the present disclosure, the light source can be or include a telecentric illuminator configured to generate parallel light beams. The parallel light beams can be red light beams, and/or can have a wavelength of approximately 631±5 nm. For example, the fluid can have a refractive index of PRESAGE phantom. A refractive index of the fluid can match a refractive index of a dosimeter. In certain exemplary embodiments of the present disclosure, a refractive index of the fluid can reduce and/or minimize light fraction at a wall-fluid interface. Octyl-salicylate and octyl-methoxy cinnamate solutions can be mixed with the fluid to match a refractive index 1.4-1.47 of a PRESAGE dosimeter.

According to certain exemplary embodiments of the present disclosure, the optic taper can collimate light beams passed through the aquarium. In certain exemplary embodiments of the present disclosure, the optic taper can be made from fiberoptic, and/or the optic taper can transmit an image by fiber filaments fused together. For example, a magnification factor for the optic taper can be approximately equal to a ratio of a big end diameter of the optic taper over a small end diameter of the optic taper. Further, a minimization factor for the optic taper can be approximately equal to a small end diameter of the optic taper over a large end diameter of the optic taper. In certain exemplary embodiments of the present disclosure, the optic taper can be configured to pass only light beams incident at the optic taper below a threshold acceptable angle, thereby significantly reduce and/or eliminate scattered artifacts. Further, the optic taper can include a number of fibers (e.g., 9) per pixel configured to preserve a high-resolution performance with the camera. In certain exemplary embodiments of the present disclosure, the optic taper has 9 fibers per pixel.

In yet further exemplary embodiments of the present disclosure, a broad-beam optical CT scanner can be provided with a fiber optic taper for collimated images, which can significantly reduce and/or eliminate scattered artifacts and spectral artifacts. The exemplary optical CT scanner can include, e.g., a telecentric broad parallel-beam source, an aquarium to house PRESAGE dosimeters, a fiber optic taper, and a CCD detector. For example, a dose distribution comparison can be performed with TPS and gamma index evaluation, which can indicate that the dose readout from such exemplary scanner can be comparable or better than the results from a single-beam scanner. The exemplary scanning time for a complete 3-D dataset acquisition can be, e.g., approximately 10-20 minutes. The exemplary optical scanner can be used for, e.g., an optical density readout of 3-D dosimeters. For example, the exemplary quality of the 3-D readout from this optical CT scanner can be better than the prior scanning system, and with a scanning time of less than 20 minutes. The exemplary scanning system can provide exemplary results which may be operator-independent.

According to certain exemplary embodiments of the present disclosure, a non-transitory computer-accessible medium having stored thereon computer-executable instructions for capturing an image of a sample are described. When a computing arrangement executes the instructions, the computing arrangement is configured to perform procedures comprising receiving the image from a camera of an optical CT scanner. For example, the optical CT scanner can include a light source (e.g., an illuminator), an aquarium comprising a motor for rotating the sample and a fluid, an optic taper, and a camera, and the aquarium can be between the light source and the optic taper and the optic taper can be in between the aquarium and the camera.

In additional exemplary embodiments of the present disclosure, exemplary optical scanner apparatus, method and computer-accessible medium for obtaining information regarding the sample are provided. In certain exemplary embodiments of the present disclosure, the optical scanner, method and computer-accessible medium can utilize a container configured to hold the sample which is provided in a fluid. A light source can be provided which is configured to emit a light radiation to the container and the sample. Further, with an optic taper, it is possible to receive, taper and combine substantially parallel beams of an output radiation exiting the sample. The output radiation can be provided in response to an irradiation of the sample by the light radiation. Further, using a light detector, it is possible to receive and detect the combined tapered parallel beams so as to obtain the information regarding the sample.

According to certain exemplary embodiments of the present disclosure, the light source can be a telecentric illuminator configured to generate parallel light beams. In some examples, the parallel light beams can be red light beams. In some examples, the parallel light beams can have a wavelength of approximately 631±5 nm. In some examples, the fluid can have a refractive index of PRESAGE® phantom. In some examples, a refractive index of the fluid can match a refractive index of a dosimeter. In some examples, a refractive index of the fluid minimizes light fraction at a wall-fluid interface. In some examples, octyl-salicylate and octyl-methoxy cinnamate solutions can be mixed with the fluid to match a refractive index in a range of approximately 1.4 to 1.47 of a dosimeter. In some examples, the optic taper can collimate the output radiation. In some examples, the optic taper can be made from a fiberoptic material. In some examples, the optic taper can transmit an image by fiber filaments fused together. In some examples, a magnification factor for the optic taper can be equal to a ratio of a big end diameter of the optic taper over a small end diameter of the optic taper. In some examples, a minimization factor for the optic taper can be equal to a small end diameter of the optic taper over a large end diameter of the taper. In some examples, the optic taper can pass solely the output radiation that is incident at the optic taper which is below a particular threshold angle, thereby reducing or eliminating scattered artifacts. In some examples, the optic taper can include a number of fibers per pixel which are configured to facilitate a high-resolution performance of the light detector. In some examples, the optic taper can have at least 9 fibers per pixel. In some examples, the optical scanner can have a motor for rotating the sample. In some examples, the light detector can be a charge-coupled device (CCD) camera.

In yet additional exemplary embodiments of the present disclosure, a further optic taper can be provided to receive the substantially parallel beams of the light radiation from the light source, and transmit the substantially parallel beams as an input radiation to the sample. In some examples, the optic taper can be configured to collimate the output radiation.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary schematic diagram of a fast optic CT scanner with a fiber optic taper for providing collimated images and other information, according to an exemplary embodiment of the present disclosure;

FIG. 2 is another exemplary schematic diagram of the fast optic CT scanner with the fiber optic taper for collimated images, according to another exemplary embodiment of the present disclosure;

FIG. 3 is an image of the fast optic CT scanner with the fiber optic taper, according to an exemplary embodiment of the present disclosure;

FIG. 4 is yet another exemplary schematic diagram of the fast optic CT scanner with the fiber optic taper, according to another exemplary embodiment of the present disclosure;

FIG. 5 is a diagram of exemplary components of the fast optic CT scanner with the fiber optic taper, according to an exemplary embodiment of the present disclosure;

FIG. 6 is a graph of an exemplary Modulation Transfer Function (MTF) versus lp/mm, according to an exemplary embodiment of the present disclosure;

FIG. 7 is an exemplary image of an exemplary comparison of acquired images using the CCD camera, according to an exemplary embodiment of the present disclosure;

FIGS. 8(a)-8(c) are exemplary illustration of exemplary an exemplary comparison of dose distributions for a H&N 7-field IMRT plan, according to an exemplary embodiment of the present disclosure;

FIGS. 9(a)-9(c) are exemplary illustration of an exemplary comparison of dose distributions for a 2-arc VMAT, according to an exemplary embodiment of the present disclosure;

FIGS. 10(a)-10(d) are exemplary illustrations of exemplary camera response linearity and signal-to-noise ratio (SNR) of different optical density (OD) level, according to an exemplary embodiment of the present disclosure;

FIG. 10(e) is an exemplary illustration an exemplary scans using the system, method and computer-accessible medium according to certain exemplary embodiments of the present disclosure;

FIG. 11 is an exemplary flow diagram for capturing image using the optic CT scanner with the fiber optic taper for obtaining the collimated images and/or other information, according to an exemplary embodiment of the present disclosure; and

FIG. 12 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures.

### DETAILED DESCRIPTION OF EXEMPLARY EMBODIMENTS

According to certain exemplary embodiments of the present disclosure, an optical CT scanner can be provided which can include a light source (e.g., a telecentric illuminator) emitting parallel light beams (e.g., red-light beams), an aquarium filled with optical matching fluid to the refractive index of the PRESAGE phantom, a taper for collimation of the transmitted light, and a CCD camera. For example, stray light due to scatter, reflections, and refractions can be removed due to the collimation effect of the fiber optic taper.

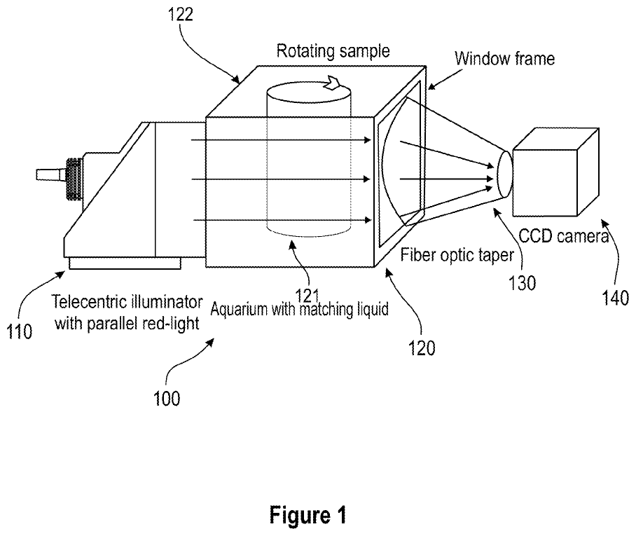

FIG. 1 shows an exemplary schematic diagram of a fast optic CT scanner 100 which is provided with a fiber optic taper for obtaining or collecting, e.g., collimated images and/or other data/information. In this exemplary embodiment, the CT scanner can include, e.g., a light source (e.g., an illuminator, laser source, etc.) 110, a container (e.g., an aquarium, etc.) 120 that can include a motor 121 and a fluid 122, an optic taper 130 (e.g., a fiber optic taper), and a light detector 140 (e.g., CCD camera 140).

In some exemplary embodiments of the methods, devices and systems of the present disclosure, a light source 110 can be provided. In some examples, the light source can be an illuminator, and the illuminator can be a telecentric illuminator (e.g., from Opto Engineering, Italy) which can provide a parallel red LED beam with a wavelength of 631±5 nm. In some examples, a wavelength of 630 nm can be selected as the wavelength for the illuminator 110 because the irradiated PRESAGE® phantom may have a peak absorption, and hence, highest signal at this wavelength. In some examples, the working distance of the range can be 20 to 35 cm. In some exemplary embodiments of the methods, devices and systems of the present disclosure, the light source 110 can irradiate light to a sample placed within the container 120 and the container 120 can pass the light to the optic taper 130. The container 120 can include a motor 121 for rotating the sample.

In some example embodiments of the example methods, devices and systems of the present disclosure, the illuminator 110 can project parallel light beams through a container 120 or an aquarium 120 containing a fluid. In some examples, the parallel light beams can have a refractive index matching the fluid. In some examples, the parallel light beams can have a radiochromic (PRESAGE) dosimeter (or a polymer gel dosimeter). In some examples, the refractive index matching fluid was selected to match the refractive index of the dosimeter and minimize the light fraction at the dosimeter wall-fluid interface. In some examples, octyl-salicylate and octyl-methoxy cinnamate solutions were mixed to match the refractive index 1.4-1.47 of PRESAGE dosimeter.

In some example embodiments of the example methods, devices and systems of the present disclosure, an optic taper 130 can be provided. In some examples, the optic taper can be a fiberoptic taper, which can transmit an image by numerous (e.g., millions) fiber filaments fused together. In some examples, a fiberoptic taper can be a bundle of optical fibers formed by a stretching process from a fused block of parallel fibers. In some examples, the optic taper 130 (e.g., fiberoptic taper) can magnify or minimize an image or incoming light. In some examples, the optic taper 130 (e.g., fiberoptic taper) can enlarge or reduce digital images. In some examples, the magnification (or minimization) factor for the optic taper 130 can be equal to the ratio of the big end diameter over the small end diameter (or the small end diameter over the large end diameter). In some exemplary embodiments of the methods, devices and systems of the present disclosure, the light received at the optic taper 130 can be tapered and combined, and provided to a light detector 140.

In some examples, the optic taper 130 can be coupled to a light detector (e.g., a CCD camera, etc.) 140. For example, the projected light of the dosimeter can pass through the optic taper 130 from the large end to the small end, and the small end can be coupled to the CCD camera 140. In these examples, when compared to a lens-based CCD camera system, direct coupling of the light source (e.g., an illuminator) with the CCD camera via an optic taper 130 (e.g., an image-preserving fiberoptics taper) can yield significant gains in the amount of light collected. In some examples, when the incident angle of a light exceeds the acceptance angle, the beam will not pass through the fiber, which can eliminate the scattered artifacts. Exemplary embodiments can have sufficient number of fibers per pixel in order to preserve the high-resolution performance with the CCD camera. For example, the recommended number of fibers per pixel can be at least nine.

In some examples, the size of components of exemplary embodiments of the exemplary system of the present disclosure can be as follows: telecentric illuminator, 14 cm; aquarium, 16 cm; window frame, 2 cm; fiberoptic taper, 12 cm; fiberoptic window; 1.5 cm; and CCD camera, 6 cm. In some examples, the size or arrangement of the system components of the present disclosure can be as follows: aquarium: 19.5 (width)×16 cm (length)×22 cm (height); Minimum beam size from the light source: 12 cm×9.9 cm; Field of view: 10×7.5 cm.

In further examples, an exemplary fiber optic taper according to certain exemplary embodiments of the present disclosure can be used to transfer and enlarge/reduce the size of an image with minimal distortion and high resolution. For example, the scatter artifact and other artifacts in the projected images can be removed almost completely due to the collimation effect of fiber optic taper. According to exemplary embodiments of the present disclosure, a pre-irradiation phantom scanning can be performed for each phantom to reduce the effect of background noise, edge artifacts, and/or other artifacts. This exemplary system is capable of measuring, e.g., 3-D dose distribution with high spatial resolution and dosimetry accuracy, and IMRT plan and a VMAT plan were used for testing.

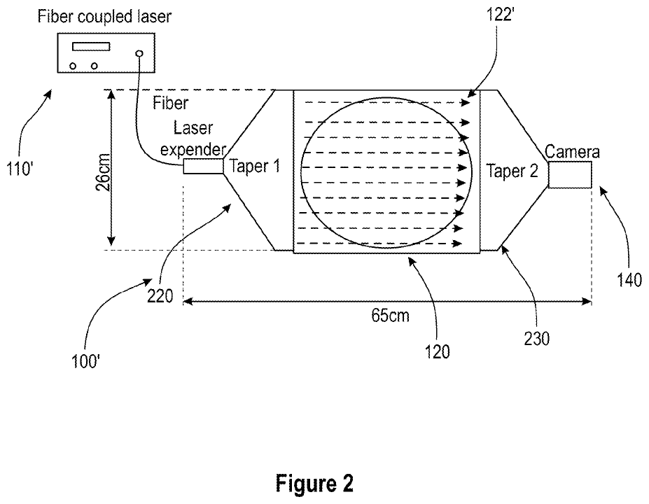

FIG. 2 shows an exemplary schematic diagram of a fast optic CT scanner with the fiber optic taper for collimated images, according to another exemplary embodiment of the present disclosure. In this exemplary embodiment, the CT scanner can include a light source (e.g., an illuminator, laser source, etc.) 110′, a container 120′ that can include a fluid 122′, a first taper 220, a second taper 230, and a CCD camera 140′. In some exemplary embodiments of the methods, devices and systems of the present disclosure, the light source 110′ can irradiate light which can pass through the second taper 230 before it impacts the sample placed in the container 120′. The second taper 230 can receive substantially parallel beams of the light radiation from the light source 110′, and transmit the substantially parallel beams as an input radiation to the sample.

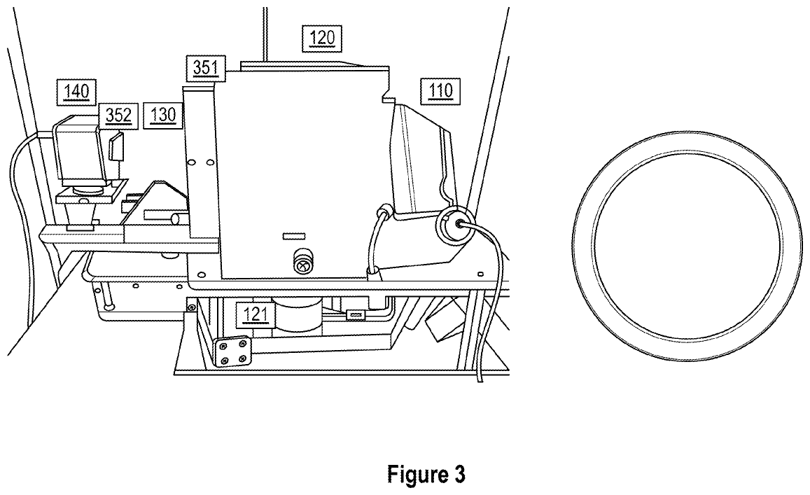

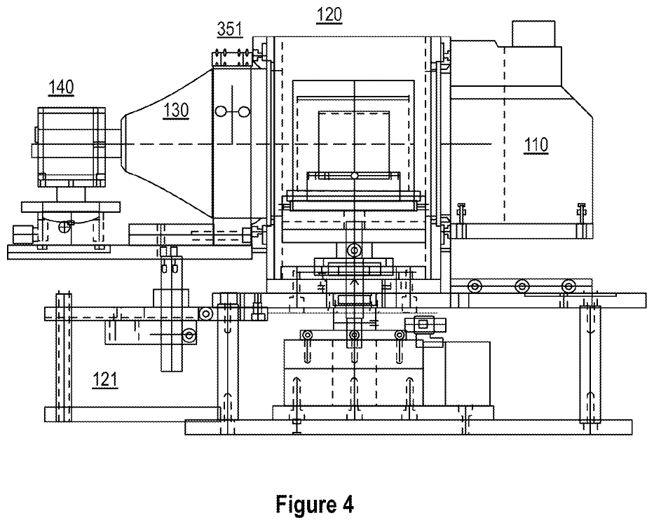

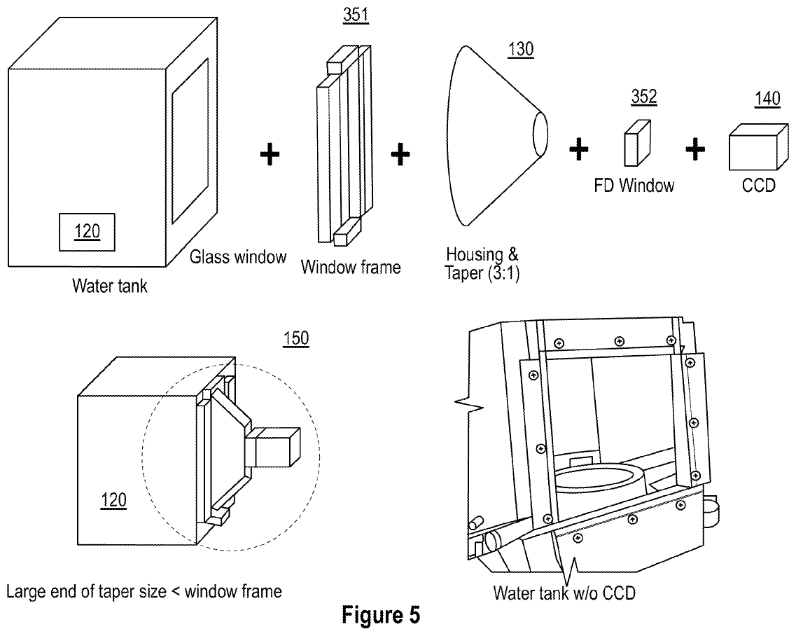

FIG. 3 shows an example photo of a fast optic CT scanner with fiber optic taper for collimated images. In this example embodiment, the CT scanner can include a light source (e.g., an illuminator, laser source, etc.) 110, an aquarium 120 including a motor 121, an optic taper 130, a CCD camera 140, a first window 351 and a second window 352. FIG. 4 shows yet another example schematic diagram of the fast optic CT scanner with fiber optic taper for collimated images. FIG. 5 shows example components of a fast optic CT scanner with fiber optic taper for collimated images. In this example, the aquarium 120, the optic taper 130, the CCD camera 140, the first window 351 and the second window 352 are displayed in a disassembled mode and in an assembled mode. The functionality of the exemplary scanners depicted in FIGS. 3-5 is substantially the same as the scanner depicted in FIG. 1.

An exemplary effect of collimation on the 3D dose measurement was studied. Spatial resolution, MTF, SNR, and image distortion tests were performed. A comparison between the broad-beam optical CT scanner using fiber optic taper and a single-beam optical raster scanner was performed for square field, conformal arc, and IMRT field dose distribution measurements. Based on previous 3D dosimetry studies, the single-beam optical CT scanner, modified from a commercial OCTOPUS scanner, may be the “gold standard” for 3D studies. The two-dimensional (2D) dose distributions generated by the broad-beam scanner were also compared to EBT3 results.

Exemplary Results: with exemplary collimated images from an fiber optic taper, according to one example, the highest spatial resolution can be estimated to be about 0.07 mm with MTF 10%. The scanning time in such example for a complete 3-D dataset acquisition can be less than 10 minutes. For dose distribution comparison in this example, using small-field conformal arcs, the gamma passing rate (2%/2 mm criteria, 10% dose threshold), was 100% between the fast broad-beam CT scanner and EBT3; and 99% between the broad-beam scanner and the single-beam scanner. All of the dose distributions from the broad-beam optical scanner were reconstructed directly from the 2D projected images without any correction for stray light. According to this example, the stray light was removed almost completely through the collimation effect of fiber optic taper.

Thus, the exemplary designed broad-beam optical CT scanner according to the exemplary embodiment of the present disclosure, utilizing fiber optic taper for collimation of transmitted lights, can provide a fast, high resolution, and accurate dose readout of 3D dosimeters.

In a further example, FOV was 7.4 cm×10 cm, and the resolution was 70 μm with MTF of about 10%. In this example, the PRESAGE was scanned before and after irradiation with the phantom at exactly the same position. The exemplary dosimeter rotates via a rotation stage at, e.g., one degree/projection (or less), such that a set of projections from various views is acquired to facilitate a 3D reconstruction. In this example, the scanning time is about 10-20 minutes. The pre-scan (I0) and post-irradiation scan (It) can remove systematic uncertainties such as dosimeter impurities and imperfections.

In still further exemplary embodiments, experiments were performed using a Varian 2100 C/D linear accelerator, converted to deliver ultra-high-dose-rate 10 MeV electron beam. The LINAC delivered approximately 0.7 Gy/pulse for FLASH irradiations. Exemplary dose rate was varied from about 40 Gy/s to 240 Gy/s by changing the repetition rate. PRESAGE phantoms were irradiated en face at six FLASH dose rates: 40 Gy/s, 80 Gy/s, 120 Gy/s, 160 Gy/s, 200 Gy/s, and 240 Gy/s. EBT film and scintillator measurements were used to verify dose. Optical response of PESAGE phantom versus delivered dose was evaluated with various known doses. A novel parallel-beam optical CT scanner, utilizing fiber optic taper for collimated images, was developed for fast, high resolution, and accurate readout of 3D dosimeters. Exemplary percent depth dose curves for various FLASH dose rates and regular dose rate were generated and compared based on the optical response versus dose measurements. Exemplary percent depth dose curves from Eclipse Monte Carlo calculation were also generated

As exemplary results of such experiment(s), the exemplary optical density of PRESAGE phantom was confirmed to be linear with absorbed dose, consistent with the observation at regular treatment dose rates. At depths past D90, percent depth dose as a function of depth for six FLASH dose rates (e.g., 240-40 Gy/s) are nearly identical, indicating that optical response of PRESAGE is dose-rate independent. At depths near to and shallower than Dmax, there was some increased uncertainty in the results due to unevenness in the phantom surface and low signal-to-noise ratio.

According to another exemplary embodiment of the present disclosure, the exemplary broad-beam optical CT scanner can include, e.g.,
a telecentric illuminator with parallel red-light beam,
an aquarium filled with optical matching fluid to match the refractive index of a dosimeter phantom placed on a rotating stage,
a window frame,
a fiber optic taper,
a CCD camera,
a bond of the fiber optic window to the CCD camera, and
a rotating motor.

With this exemplary embodiment, the exemplary scanner can utilize a fiber optic taper for 3D dosimetry. Fiber optic taper can be used to transfer as well as enlarge and/or reduce the size of an image with minimal distortion and high resolution. For example, with the exemplary embodiment of the present disclosure, the stray light and spectral artifacts in the reconstruction of 3D dose distribution can be removed, e.g., almost completely, due to the collimation effect of fiber optic taper. As an exemplary result, the exemplary embodiments of the broad-beam optical CT scanner with the fiber optic taper can provide an important readout device for a 3D radiation dosimeter. The exemplary benefits can be that such exemplary devices are fast, reproducible, high-resolution, and accurate 3D optical CT scanner.

According to another exemplary embodiment of the present disclosure, the exemplary device utilizes one or more optical fibers so as to provide a collimation effect. Indeed, it is not necessary to provide an error calibration for uncertainty, according to exemplary embodiments of the present disclosure. For example, an LED light source delivers light through optical fiber(s) (e.g., tapered fiber(s)), and the resultant radiation is provided on the CCD camera on the other side. The tapering can be based on the imaging sensor, and the tapering is utilized so as to determine which fiber corresponds the point on the image sensor. In phantom dark, e.g., the color means larger dose, and the darker light absorbs more light.

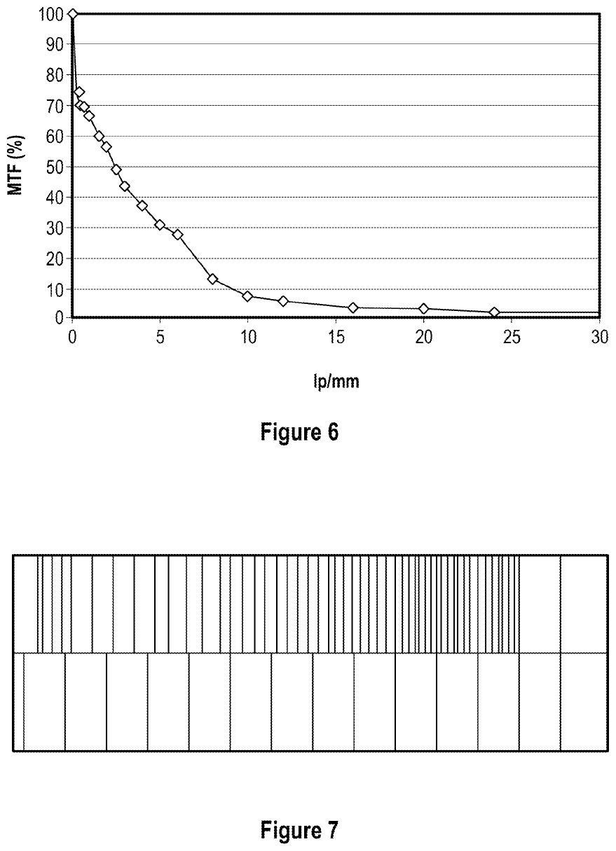

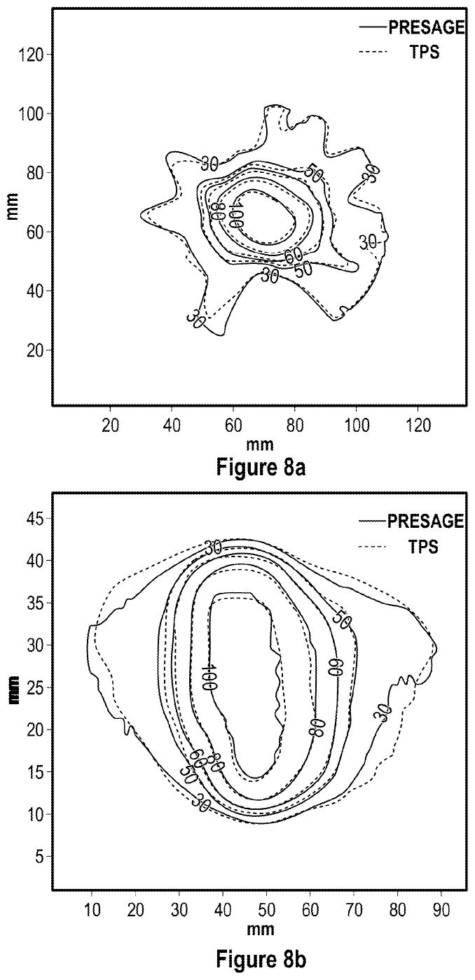

FIG. 6 shows a graph of the exemplary experimental MTF as a function of lp/mm, according to an exemplary embodiment of the present disclosure. In the exemplary fiber optic taper, for example, the resolution of the big end can be different from that the resolution thereof at the small end. Smaller fiber diameter can have a higher resolution. For example, according to one exemplary embodiment, a high end of the resolution can be approximately 0.07 mm with MTF of about 10%, which is a very high spatial resolution for external beam dosimetric measurements. FIG. 7 shows exemplary comparison of acquired images using the CCD camera. FIG. 7 shows an illustration of an exemplary comparison of acquired images using the CCD camera according to an exemplary embodiment of the present disclosure.

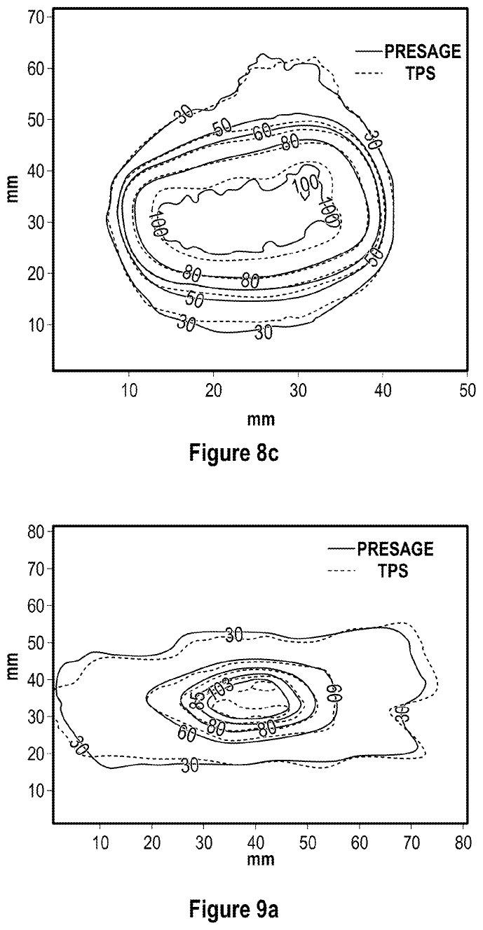

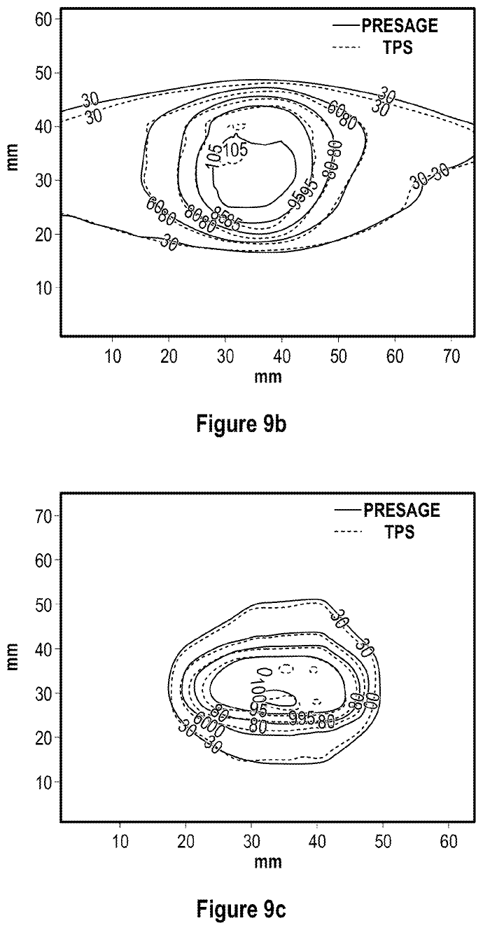

FIGS. 8(a)-8(b) show illustrations which provide an exemplary comparison of dose distributions for a H&N 7-field IMRT plan between Eclipse planning calculation and PRESAGE measurement along a central transverse plane (see FIG. 9(a)), a coronal plane (see FIG. 9(b)), and a sagittal plane (see FIG. 9(c)). FIGS. 8(a)-8(c) illustrate a beneficial and appropriate agreement of exemplary dose distributions between planning calculation and PRESAGE measurement with optical density readout using the novel optical CT scanner from an example embodiment of the present disclosure. For example, such illustrations are provided with the gamma index passing rates with the 3%/2 mm criteria are about 97.1% for the central transverse plane, about 98.4% for the coronal plane, and about 99.1% for the sagittal plane. FIG. 9(a)-9(c) show illustrations of an exemplary comparison of the dose distributions for a 2-arc VMAT plan between Eclipse planning calculation and PRESAGE measurement a central transverse plane (see FIG. 9(a)), a coronal plane (see FIG. 9(b)), and a sagittal plane (see FIG. 9(c)) according to an exemplary embodiment of the present disclosure. FIGS. 9(a)-9(c) illustrate an exemplary beneficial and appropriate agreement of dose distributions between planning calculation and PRESAGE measurement for a VMAT SBRT plan. For example, such illustrations are provided with the gamma index passing rates with 3%/2 mm criteria are about 99.4% for the central transverse plane, about 98.0% for the central coronal plane, and about 99.0% for the central sagittal plane, respectively.

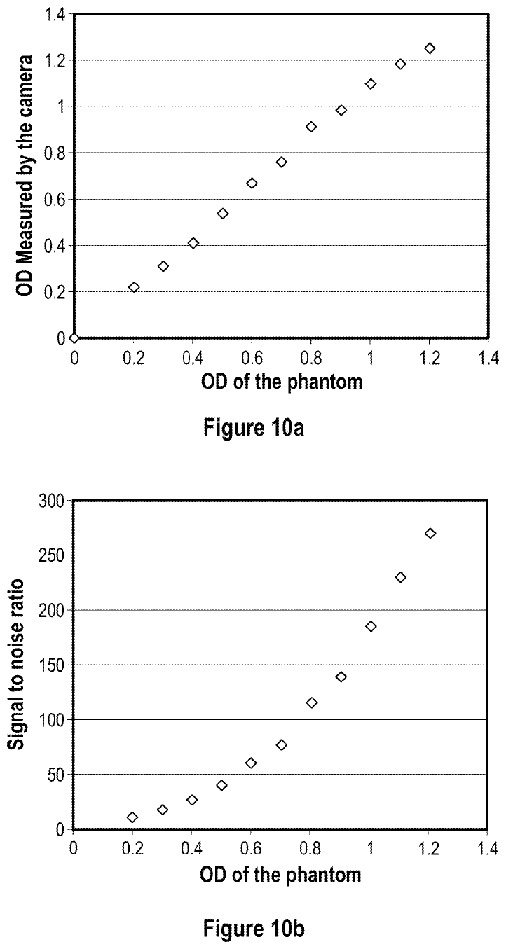

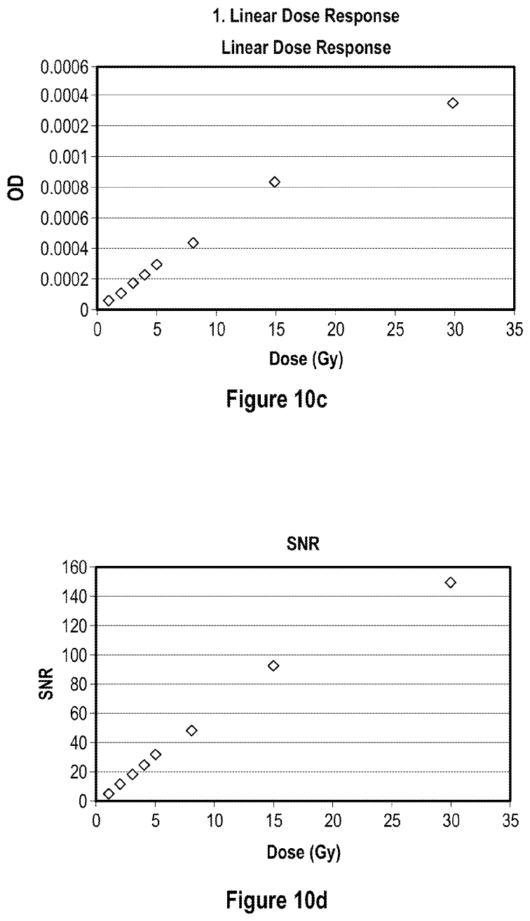

FIGS. 10(a)-10(d) illustrate an exemplary camera response linearity and SNR of different OD level, according to exemplary embodiments of the present disclosure. In particular. FIG. 10(a) shows an exemplary linear optical response of fiberoptic taper and CCD camera system as a function of optical density. Phantoms with various known optical densities were used for testing the optical response of the system. In some example embodiments, measured optical density can be linear with the optical density of phantom.

FIG. 10(b) shows exemplary signal-to-noise ratio (“SNR”) of the fiberoptic taper and CCD camera system as a function of optical density. Phantoms with various known optical densities were used for testing the SNR of the system. In this example, SNR was obtained from the calculation of the following ratio: mean of the signal-mean of the background over standard deviation of the background. These exemplary SNR results are very high, ranging from 10.3 to 269. Similar experiments were performed for linearity and SNR given 3-D phantoms with known radiation doses. The linearity of optical response and SNR as a function of radiation dose were presented in FIGS. 10(c) and 10(d).

FIG. 10(e) shows an exemplary scans (i.e., blue, red, and green). The reconstructed dose images can be reproducible.

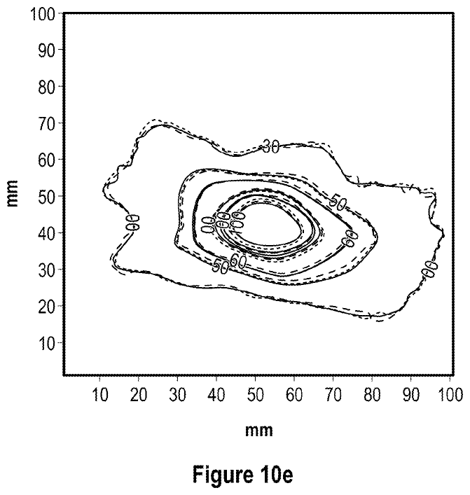

FIG. 11 shows an exemplary flow diagram for a method of capturing image using an optic CT scanner 100 with fiber optic taper 130 for collimated images, according to exemplary embodiments of the present disclosure. For this exemplary method, in a step 1110, a sample can be placed in an aquarium. In a step 1120, an illuminator 110 can transmit light, laser beams or other radiation to the sample while the sample is being rotated in the aquarium. In the step 1130, a CCD camera 140 (or another light or radiation detector) can capture images of the light transmitted through the aquarium 120 and the sample.

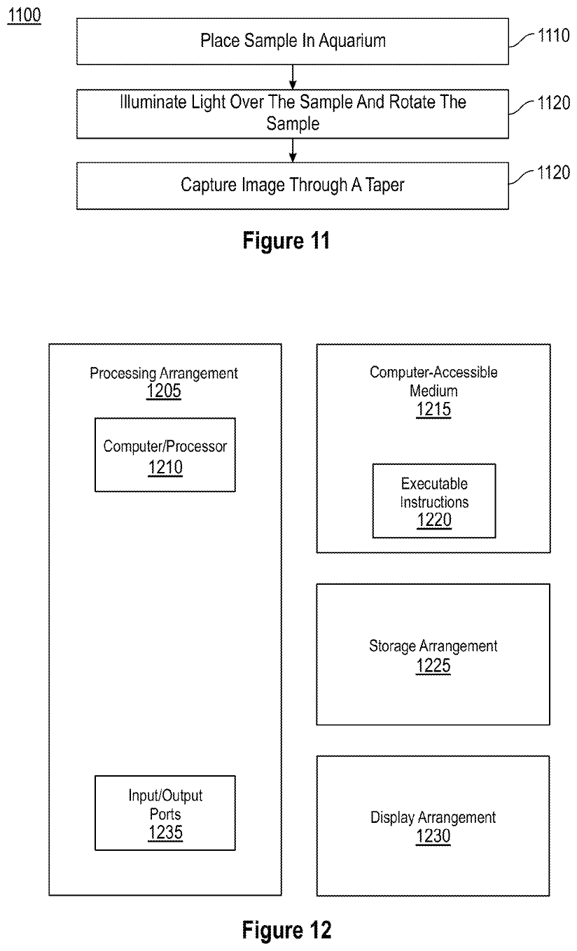

FIG. 12 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) 1205. Such processing/computing arrangement 1205 can be, for example entirely or a part of, or include, but not limited to, a computer/processor 1210 that can include, for example one or more microprocessors, and use instructions stored on a computer-accessible medium (e.g., RAM, ROM, hard drive, or other storage device).

As shown in FIG. 12, for example a computer-accessible medium 1215 (e.g., as described herein above, a storage device such as a hard disk, floppy disk, memory stick, CD-ROM, RAM, ROM, etc., or a collection thereof) can be provided (e.g., in communication with the processing arrangement 1205). The computer-accessible medium 1215 can contain executable instructions 1220 thereon. In addition or alternatively, a storage arrangement 1225 can be provided separately from the computer-accessible medium 1215, which can provide the instructions to the processing arrangement 1205 so as to configure the processing arrangement to execute certain exemplary procedures, processes, and methods, as described herein above, for example.

Further, the exemplary processing arrangement 1205 can be provided with or include an input/output ports 1235, which can include, for example a wired network, a wireless network, the internet, an intranet, a data collection probe, a sensor, etc. As shown in FIG. 12, the exemplary processing arrangement 1205 can be in communication with an exemplary display arrangement 1230, which, according to certain exemplary embodiments of the present disclosure, can be a touch-screen configured for inputting information to the processing arrangement in addition to outputting information from the processing arrangement, for example. Further, the exemplary display arrangement 1230 and/or a storage arrangement 1225 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference, in their entireties:
1. Xu, Y., Wuu, C. S., and Maryanski, M. Determining Optimal Gel Sensitivity in Optical CT scanning of Polymer gels, Med. Phys., 30, 2257-2263, 2003.
2. Xu, Y., Wuu, C. S., and Maryanski, M. Performance of Optical CT Scanning of Polymer Gels as a Tool for 3D Dose Verification, Med. Phys., 31, 3024-3032, 2004.
3. Wuu, C. S., Xu, Y. and Maryanski, M. 3-D dose verification for IMRT using optical CT based polymer gel dosimetry, Journal of Physics: conference series 3, 297-300, 2004.

What is claimed is:

1. An optical scanner apparatus for obtaining information regarding a sample, comprising:
a container configured to hold the sample which is provided in a fluid;
a light source configured to emit a light radiation to the container and the sample;
an optic taper configured to receive, taper and combine substantially parallel beams of an output radiation exiting the sample, wherein the output radiation is provided in response to an irradiation of the sample by the light radiation; and
a light detector configured to receive and detect the combined tapered parallel beams so as to obtain the information regarding the sample.

2. The optical scanner apparatus of claim 1, wherein the light source is a telecentric illuminator configured to generate parallel light beams.

3. The optical scanner apparatus of claim 2, wherein the parallel light beams are red light beams.

4. The optical scanner apparatus of claim 3, wherein the parallel light beams have a wavelength of approximately 631±5 nm.

5. The optical scanner apparatus of claim 1, wherein the fluid has a refractive index of PRESAGE® phantom.

6. The optical scanner apparatus of claim 1, wherein a refractive index of the fluid matches a refractive index of a dosimeter.

7. The optical scanner apparatus of claim 1, wherein a refractive index of the fluid minimizes light fraction at a wall-fluid interface.

8. The optical scanner apparatus of claim 1, wherein octyl-salicylate and octyl-methoxy cinnamate solutions are mixed with the fluid to match a refractive index in a range of approximately 1.4 to 1.47 of a dosimeter.

9. The optical scanner apparatus of claim 1, wherein the optic taper is configured to collimate the output radiation.

10. The optical scanner apparatus of claim 1, wherein the optic taper is made from a fiberoptic material.

11. The optical scanner apparatus of claim 1, wherein the optic taper is configured to transmit an image by fiber filaments fused together.

12. The optical scanner apparatus of claim 1, wherein a magnification factor for the optic taper is equal to a ratio of a big end diameter of the optic taper over a small end diameter of the optic taper.

13. The optical scanner apparatus of claim 1, wherein a minimization factor for the optic taper is equal to a small end diameter of the optic taper over a large end diameter of the taper.

14. The optical scanner apparatus of claim 1, wherein the optic taper is configured to pass solely the output radiation that is incident at the optic taper which is below a particular threshold angle, thereby reducing or eliminating scattered artifacts.

15. The optical scanner apparatus of claim 1, wherein the optic taper includes a number of fibers per pixel which are configured to facilitate a high-resolution performance of the light detector.

16. The optical scanner apparatus of claim 15, wherein the optic taper has at least 9 fibers per pixel.

17. The optical scanner apparatus of claim 1, further comprising a motor for rotating the sample.

18. The optical scanner apparatus of claim 1, wherein the light detector is a charge-coupled device (CCD) camera.

19. The optical scanner apparatus of claim 1, further comprising a further optic taper configured to receive the substantially parallel beams of the light radiation from the light source, and transmit the substantially parallel beams as an input radiation to the sample.

20. The optical scanner apparatus of claim 19, wherein the optic taper is configured to collimate the output radiation.

21. The optical scanner apparatus of claim 1, wherein the light source includes telecentric broad parallel-beam source.

22. The optical scanner apparatus of claim 1 further comprising at least one computer which is configured to receive the information, and perform a dose distribution comparison based on a gamma index evaluation.

23. A method for obtaining information regarding a sample, comprising:
emitting a light radiation from the light source to a sample which is provided in a fluid within a container, wherein substantially parallel beams of an output radiation exiting the sample are received, tapered and combined by an optic taper, wherein the output radiation is provided in response to an irradiation of the sample by the light radiation; and
receiving and detecting the combined tapered parallel beams by a light detector so as to obtain the information regarding the sample.

24. A non-transitory computer-accessible medium having stored thereon computer-executable instructions for obtaining information regarding a sample, wherein, when a computing arrangement executes the instructions, the computing arrangement is configured to perform procedures comprising:
causing emission of a light radiation from the light source to a sample which is provided in a fluid within a container, wherein substantially parallel beams of an output radiation exiting the sample are received, tapered and combined by an optic taper, wherein the output radiation is provided in response to an irradiation of the sample by the light radiation; and
causing receipt and detection of the combined tapered parallel beams by a light detector so as to obtain the information regarding the sample.
